(19) United States
(12) Patent Application Publication
(10) Pub. No.: US 2009/0137271 A1
(43) Pub. Date: May 28, 2009

(54) CAMERA PHONE AND REAL-TIME ADDRESSING IMAGE TRANSMISSION METHOD THEREOF

(76) Inventor: Chih-Chen Wu, PINGTUNG COUNTY (TW)

Correspondence Address: MORRIS MANNING MARTIN LLP, 3343 PEACHTREE ROAD, NE, 1600 ATLANTA FINANCIAL CENTER, ATLANTA, GA, 30326, US

(21) Appl. No.: 12/052,826

(22) Filed: Mar. 21, 2008

(30) Foreign Application Priority Data
Nov. 28, 2007 (TW) 096145270

(51) Int. Cl. H04M 1/00

(52) U.S. Cl. 455/556.1

(57) ABSTRACT

A camera phone and a real-time addressing image transmission method thereof are provided. The camera phone includes a photographing module, an addressing module for storing a network address of a receiving end, and a real-time transmission module. A sight is photographed to generate a media data corresponding to the sight by using the photographing module. The addressing module is read by the real-time transmission module to judge whether the network address of the receiving end is stored or not, and the media data is transmitted to the receiving end if the network address is stored. The apparatus and method could be utilized to photograph scenes and behavior of persons involved in the moment of taking a taxi, traffic accidents, active crimes, or activities, and transmit them immediately to a designated receiving end, so as to conserve images numerously and effectively without occupying a memory space of the camera phone.

This application claims the benefit of Taiwan Patent Application No. 096145270, filed on Nov. 28, 2007, which is hereby incorporated by reference for all purposes as if fully set forth herein.

### BACKGROUND OF THE INVENTION

1. Field of Invention

The present invention relates to an image transmission method, especially for a camera phone and a real-time addressing image transmission method thereof, which could transmit photographed images in real-time to a designated receiving end.

2. Related Art

In the prior art, an user could photograph scenes by utilizing a camera phone which has a photographing module, so as to generate corresponding images and store them in the camera phone or an expanding memory unit. If the user wants to share or transmit the images, he should utilize a manual mode to transmit the images to a designated computer or a designated server through multimedia messages or networks, or he could transmit the images to the designated computer or the designated server through a signal transmission cable, which is connected the camera phone with the designate computer or the designate server.

However, the prior art includes some unavoidable defects as following:

First, in the emergent or urgent situations, such as crime scenes, traffic accidents, or taking transportation (taxi, bus, and etc.), if users still need to control the image transmitting work manually, the photographed images would be hardly to be transmitted immediately and evidences would be hardly to be conserved.

Second, the amount of captured images and the total amount of stored images of the camera phone are restricted within a memory space of its memory unit. If the memory space is fully occupied, the camera phone would not execute the work of photographing sights, and the camera phone would not capture images numerously over a long period of time.

### SUMMARY OF THE INVENTION

In view of the above problems, an object of the present invention is to provide a camera phone and a real-time addressing image transmission method thereof, which is able to transmit photographed images in real-time and collect media data of images or pictures numerously over a long period of time.

In order to solve the above mentioned problems, a technical means of the present invention discloses a camera phone, which includes an addressing module, a photographing module, and a real-time transmission module. The addressing module stores at least a network address of a receiving end, and the photographing module is used to photograph a sight to generate a corresponding media data. The real-time transmission module obtains the media data and reads the network address of the receiving end, so as to transmit the media data to the receiving end.

In order to solve the above mentioned problems, the technical means of the present invention discloses a real-time addressing image transmission method for a camera phone, which includes steps of photographing a sight to form a media data, and judging whether at least a network address of a receiving end is stored or not. If the network address is stored, the media data is transmitted to the receiving end. If the network address is not stored, the media data is stored in the camera phone or deleted directly.

In the above technical means disclosed by the present invention, the camera phone utilizes a multimedia messaging technology, a user datagram protocol (UDP), a transmission control protocol (TCP), or a streaming media technology to transmit the media data to the receiving end. The receiving end could be a computer or a server, and the media data could be a picture or an image.

The present invention includes effects, which are not achieved by the prior art, as following:

First, the media data photographed by the camera phone could be transmitted immediately to the receiving end, so as to conserve images of scenes right the first time in every emergent situation, and avoid the camera phone being broken and evidences of images being destroyed before the images are transmitted.

Second, the media data photographed by the camera phone is unnecessary to be stored in the camera phone. Therefore, the needed scenes could be photographed numerously by the camera phone over a long period of time.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 is a schematic diagram of a camera phone connecting with a receiving end according to an exemplary embodiment of the present invention;

FIG. 2 is a first flow chart of a real-time addressing image transmission method of a camera phone according to an exemplary embodiment of the present invention;

FIG. 3 is a second flow chart of a real-time addressing image transmission method of a camera phone according to an exemplary embodiment of the present invention;

FIG. 4 is a third flow chart of a real-time addressing image transmission method of a camera phone according to an exemplary embodiment of the present invention;

FIG. 5 is a schematic diagram of photographing a taxi before taking the taxi according to an exemplary embodiment of the present invention;

FIG. 6 is a schematic diagram of photographing a scene of a traffic accident according to an exemplary embodiment of the present invention;

FIG. 7 is a schematic diagram of photographing a scene of a crime according to an exemplary embodiment of the present invention;

FIG. 8 is a schematic diagram of photographing a scene of an activity according to an exemplary embodiment of the present invention; and

FIG. 9 is a schematic diagram of photographing a sight according to an exemplary embodiment of the present invention.

### DETAILED DESCRIPTION OF THE INVENTION

The features and practice of the present invention will be illustrated below in detail through preferred embodiments with reference to the accompanying drawings.

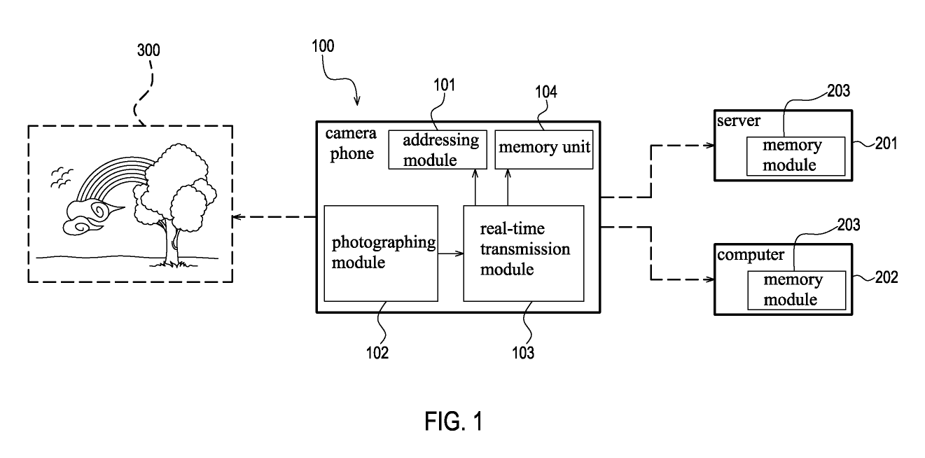

Referring to FIG. 1, it is a schematic diagram of a camera phone connecting with a receiving end according to an exemplary embodiment of the present invention.

A camera phone 100 includes an addressing module 101, a photographing module 102, and a real-time transmission module 103. The addressing module 101 stores at least a network address of a receiving end. In this exemplary embodiment, the addressing module 101 has stored the network addresses of a server 201 and a computer 202. Each of the server 201 and the computer 202 includes a memory module 203, in which at least a memory space (not shown in FIG. 1) is divided from the memory module 203, and each memory space is corresponding to a number of the camera phone 100.

The photographing module 102 is used for a user to photograph a sight 300 in his location, so as to form a media data, which has been stored temporarily. The real-time transmission module 103 obtains the media data and reads the network addresses of the server 201 and the computer 202, which are stored in the addressing module 101, so as to transmit the media data to the server 201 and the computer 202 of the receiving end according to the network addresses. The server 201 and the computer 202 have known the corresponding number of the camera phone 100 through the received media data, so as to store the media data in the memory space of the memory module 203 corresponding to the number.

Furthermore, the camera phone 100 includes a control interface for users to add, delete, or change network addresses, amounts, or names of receiving ends stored in the addressing module 101.

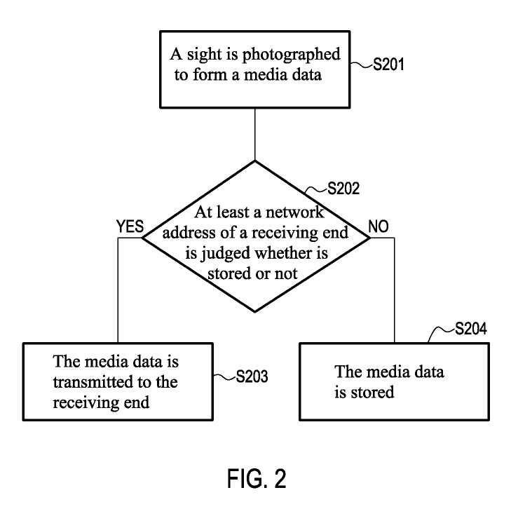

FIG. 2 is a first flow chart of a real-time addressing image transmission method of a camera phone according to an exemplary embodiment of the present invention. Referring to FIG. 1 and FIG. 2 in the same time, a real-time addressing image transmission method of a camera phone includes steps as following:

A sight is photographed to form a media data (Step 201). When a user utilizes the camera phone 100 to photograph a sight 300, a media data corresponding to a lens of the camera phone 100 is formed by the photographing module 102. Therein, the media data could be a picture or an image.

At least a network address of a receiving end is judged whether is stored or not (Step 202). After the real-time transmission module 103 obtains the media data, the addressing module 101 is read to judge whether any network address is stored or not.

If the network address is stored, the media data is transmitted to the receiving end (Step 203). It includes transmission modes as following: (1) A multimedia messaging technology is utilized to transmit the media data to the receiving end. (2) A network connecting mode is utilized to upload the media data to the computer 202 or the server 201 corresponding to the network address. The media data is transmitted according to a user datagram protocol (UDP) or a transmission control protocol (TCP). (3) If the media data is a continuing image, a streaming media technology is utilized to transmit the image to the receiving end. Then, the media data is obtained by the server 201 and the computer 202, and is stored in the memory space of the memory module 203 corresponding to the number of the camera phone 100.

If the network address is not stored, the media data is stored (Step 204) in a memory unit 104 of the camera phone 100.

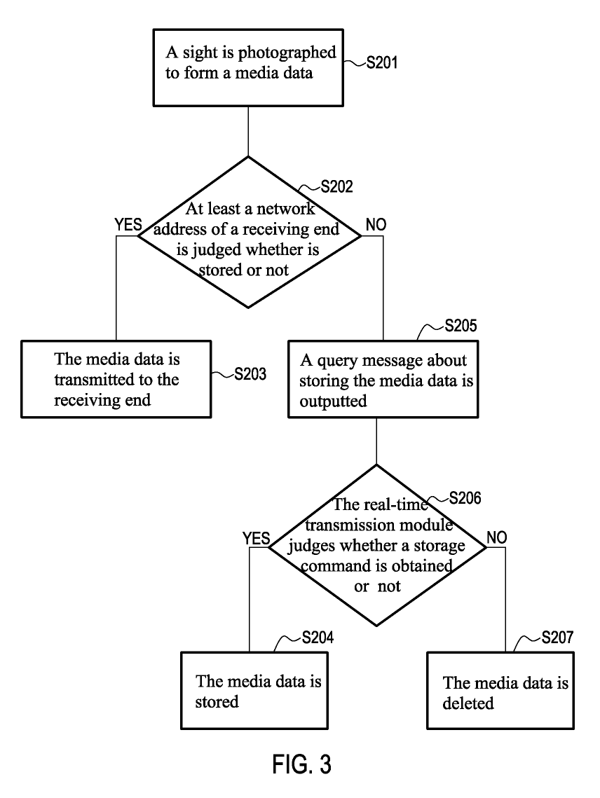

Referring to FIG. 3, it is a second flow chart of a real-time addressing image transmission method of a camera phone according to an exemplary embodiment of the present invention. Compared to the first flow shown in FIG. 2, the difference of the second flow is that a query message about storing the media data is outputted (Step 205) when the real-time transmission module 103 judges that there is not any network addresses of the receiving end has been stored in the addressing module 101, so as to query the user whether to store the media data in the camera phone or not, and also inform the user how to input a command.

Then, the real-time transmission module 103 judges whether a storage command is obtained or not (Step 206). If the storage command is obtained, the media data is stored (Step 204). If the storage command is not obtained, the media data is deleted (Step 207), so as to avoid occupying a memory space of the memory unit 104. The step is used for the user to initially choice the media data, which is needed, before the user stores the media data in the camera phone 100.

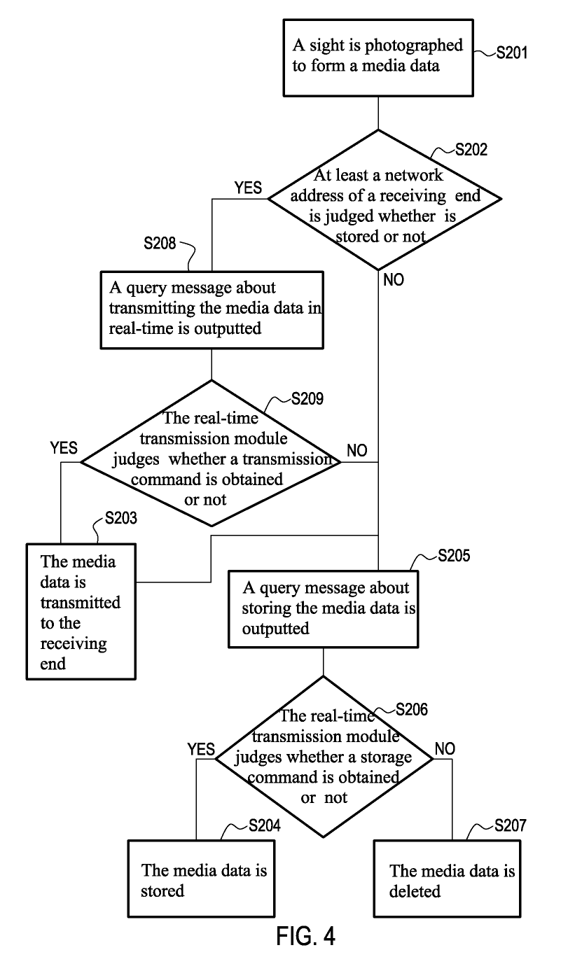

Referring to FIG. 4, it is a third flow chart of a real-time addressing image transmission method of a camera phone according to an exemplary embodiment of the present invention. Compared to the second flow shown in FIG. 3, the difference of the third flow is that a query message about transmitting the media data in real-time is outputted (Step 208) when the real-time transmission module 103 judges that there is at least a network addresses of the receiving end has been stored in the addressing module 101, so as to query the user whether to transmit the media data in real-time or not, and also inform the user how to input a command.

Then, the real-time transmission module 103 judges whether a transmission command is obtained or not (Step 209). If the transmission command is obtained, the media data is transmitted to the receiving end (Step 203). The user could decide whether the real-time transmission function is used or not according to the urgency of scenes to transmit the media data in real-time.

If the real-time transmission module 103 has judged that the addressing module 101 does not store any network address of the receiving end, the real-time transmission module 103 does not obtain any transmission command (not obtaining in a specific time or the user inputting a control command of un-transmitting in real-time), or the media data has been transmitted in real-time, a query message about storing the media data is outputted (Step 205) through the real-time transmission module 103, so as to query the user to store the media data in the camera phone or not, and also inform the user how to input a command.

Then, the real-time transmission module 103 judges whether a storage command is obtained or not (Step 206). If the storage command is obtained, the media data is stored (Step 204) in the memory unit 104 of the camera phone 100. If the storage command is not obtained (the user not inputting the storage command in a specific time or the user inputting a control command of un-storing the media data), the media data is deleted (Step 207) by the real-time transmission module 103, so as to avoid occupying the memory space of the memory unit 104.

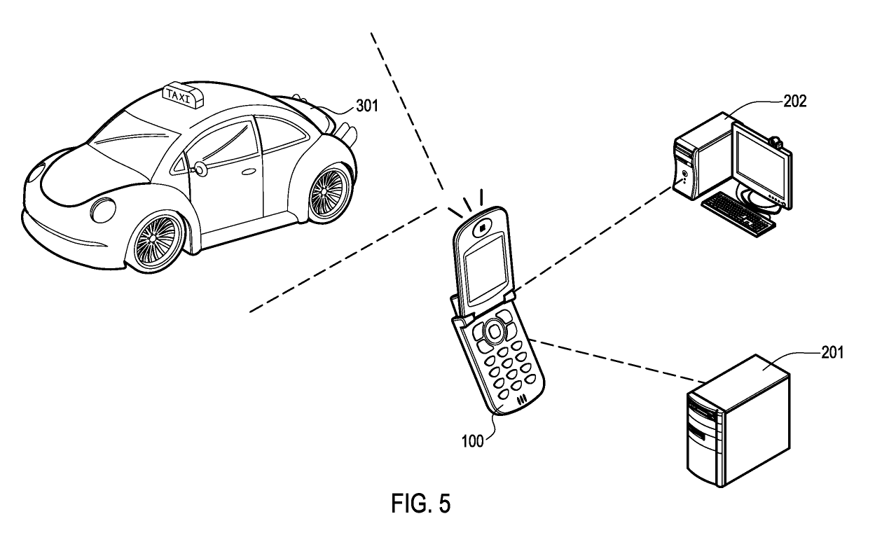

Referring to FIG. 5, it a schematic diagram of photographing a taxi before taking the taxi according to an exemplary embodiment of the present invention. The time is very short from a taxi 301 stopping to a user opening a car door and getting into the taxi 301. The user could utilize the camera phone 100 to photograph an appearance, features, and a license plate of the taxi 301, and utilize the real-time transmission module 101 to transmit the photographed media data to the computer 202 and server 201 in real-time for conserving an evidence of taking the taxi 301.

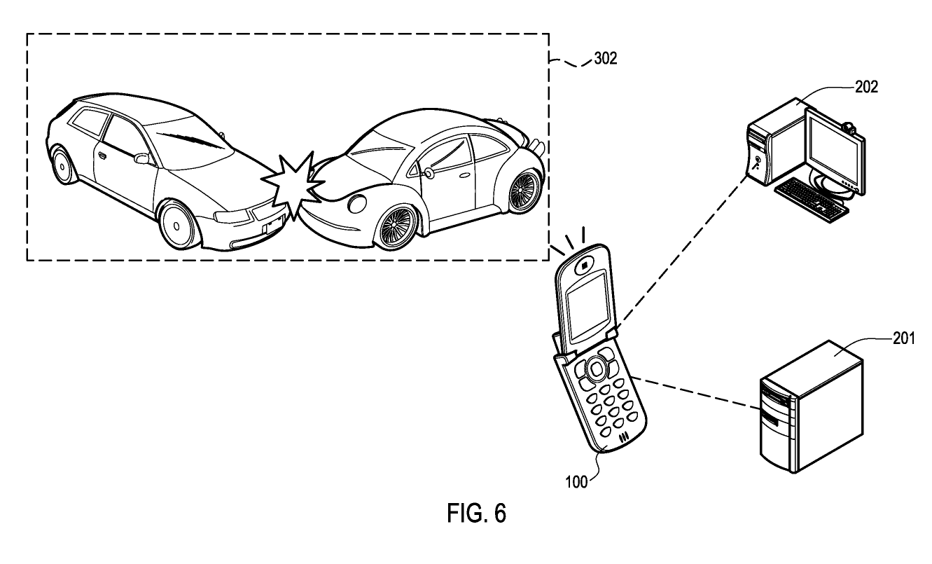

Referring to FIG. 6, it is a schematic diagram of photographing a scene of a traffic accident according to an exemplary embodiment of the present invention. The user could utilize the camera phone 100 to photograph a scene of a traffic accident to obtain a traffic accident picture 302, and transmit the traffic accident picture 302 to the server 201 and the computer 202 in real-time, so as to conserve an evidence and prevent a troublemaker from escaping.

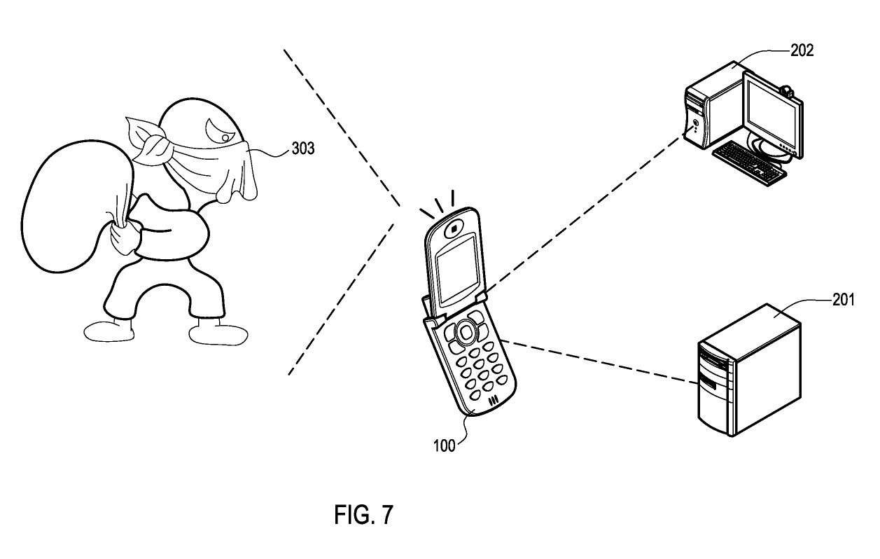

Referring to FIG. 7, it is a schematic diagram of photographing a scene of a crime according to an exemplary embodiment of the present invention. The user could utilize the camera phone 100 to photograph an appearance, features, and criminal behavior of an active crime scene 303, and transmit the pictures and images in real-time to the server 201 and the computer 202 for conserving an evidence effectively. Even if the camera phone 100 has been broken, the criminal process could be known through the pictures and the images, which are taken from the computer 202 and the server 201.

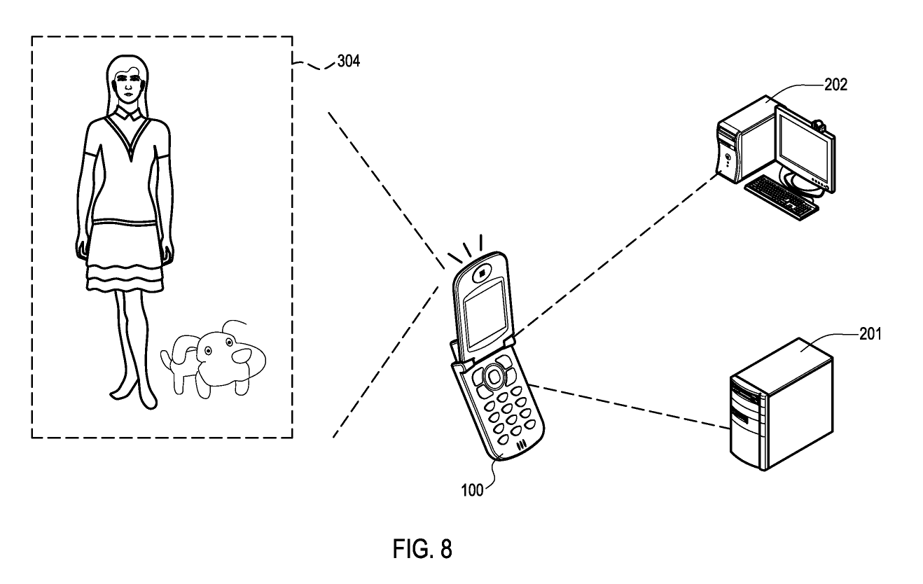

Referring to FIG. 8, it is a schematic diagram of photographing a scene of an activity according to an exemplary embodiment of the present invention. The user may preset the server 201 and the computer 202 to which the camera phone 100 is transmitted and construct a memory space and a displaying homepage (not shown in FIG. 8) in the server 201 and the computer 202 corresponding to the number of the camera phone 100. When the user utilizes the camera phone 100 to photograph pictures of daily life, activities, travel, work, and etc., these pictures and images could be transmitted to the server 201 and the computer 202 by utilizing the real-time transmission module 103. These pictures and images are stored in the memory space of the server 201 and the computer 202 corresponding to the number of the camera phone 100, and a corresponding path is set on the displaying homepage for other computer users to connect the server 201 and the computer 202 to view and enjoy these pictures and images through the displaying homepage.

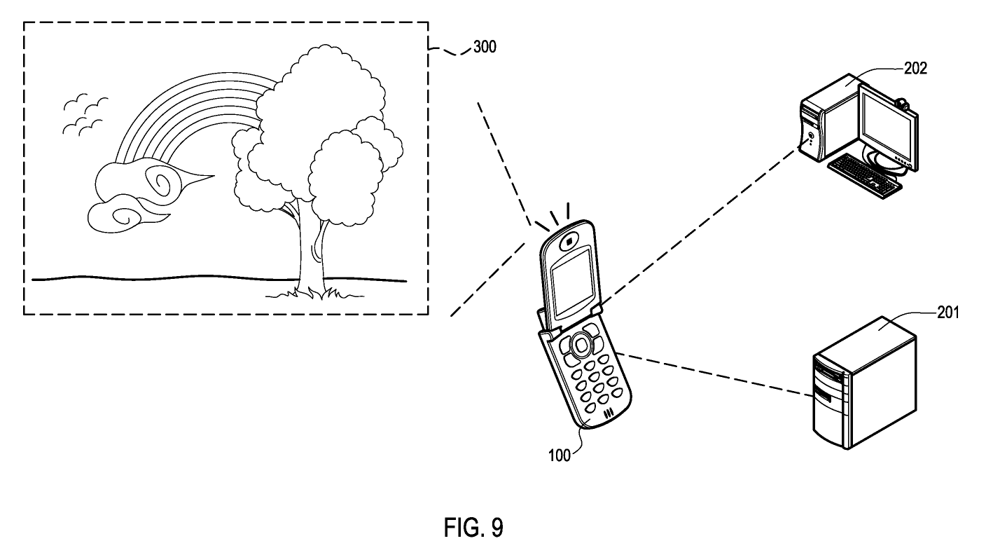

Referring to FIG. 9, it is a schematic diagram of photographing a sight according to an exemplary embodiment of the present invention. When the user utilizes the camera phone 100 photographed a sight 300, the user can use the real-time transmission module 103 to transmit the media data to the computer 202 and the server 201 in the whole photographing period without storing them in the camera phone 100; therefore, the storage amount and the storage space of the media data are not restricted to the memory space of the memory unit 104 in the camera phone 100, so the camera phone 100 has infinite space for storing the media data. However, the user also could selectively sore the media data in the camera phone 100, and view the favorite images and pictures in anytime.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A real-time addressing image transmission method for a camera phone, comprising following steps:
photographing a sight to form a media data; and
judging whether at least a network address of a receiving end is stored or not, and transmitting the media data to the receiving end if the network address is stored.

2. The real-time addressing image transmission method for a camera phone as claimed in claim 1, wherein the media data is stored if the network address is not stored.

3. The real-time addressing image transmission method for a camera phone as claimed in claim 1, wherein a query message about storing the media data is outputted if the network address is not stored, then whether a storage command is obtained or not is judged, and the media data is stored if the storage command is obtained or the media data is deleted if the storage command is not obtained.

4. The real-time addressing image transmission method for a camera phone as claimed in claim 1, wherein the camera phone utilizes a multimedia messaging technology to transmit the media data to the receiving end.

5. The real-time addressing image transmission method for a camera phone as claimed in claim 1, wherein the media data is a picture or an image.

6. The real-time addressing image transmission method for a camera phone as claimed in claim 5, wherein the camera phone utilizes a streaming media technology to transmit the image or the picture to the receiving end.

7. The real-time addressing image transmission method for a camera phone as claimed in claim 1, wherein the receiving end is a server or a computer.

8. A camera phone, comprising:
an addressing module, wherein at least a network address of a receiving end is stored in the addressing module;
a photographing module, wherein a sight is photographed and a media data corresponding to the sight is generated by the photographing module; and
a real-time transmission module, wherein the media data is obtained and the network address of the receiving end is read by the real-time transmission module, so as to transmit the media data to the receiving end.

9. The camera phone as claimed in claim 8, wherein the camera phone utilizes a multimedia messaging technology to transmit the media data to the receiving end.

10. The camera phone as claimed in claim 8, wherein the media data is a picture or an image.

11. The camera phone as claimed in claim 10, wherein the image or the picture is transmitted to the received end through a streaming media technology.

12. The camera phone as claimed in claim 8, wherein the receiving end is a server or a computer.

13. A real-time addressing image transmission method for a camera phone, comprising following steps:
photographing a sight to form a media data;
judging whether at least a network address of a receiving end is stored or not, and outputting a query message about transmitting the media data in real-time if the network address is stored;
judging whether a transmission command is obtained or not, and transmitting the media data to the receiving end if the transmission command is obtained; and
outputting a query message about storing the media data, judging whether a storage command is obtained or not, and storing the media data if the storage command is obtained or deleting the media data if the storage command is not obtained.

14. The real-time addressing image transmission method for a camera phone as claimed in claim 13, wherein the camera phone utilizes a multimedia messaging technology to transmit the media data to the receiving end.

15. The real-time addressing image transmission method for a camera phone as claimed in claim 13, wherein the media data is a picture or an image.

16. The real-time addressing image transmission method for a camera phone as claimed in claim 15, wherein the image or the picture is transmitted to the received end through a streaming media technology.

17. The real-time addressing image transmission method for a camera phone as claimed in claim 13, wherein the camera phone includes an addressing module to store the network address of the receiving end.

18. The real-time addressing image transmission method for a camera phone as claimed in claim 13, wherein the receiving end is a server or a computer.
